(19) United States
(12) Patent Application Publication
(10) Pub. No.: US 2018/0317205 A1
(43) Pub. Date: Nov. 1, 2018

(54) USER EQUIPMENT AND SIGNAL RECEPTION METHOD

(71) Applicant: NTT DOCOMO, INC., Tokyo (JP)

(72) Inventors: Kazuaki Takeda, Tokyo (JP); Satoshi Nagata, Tokyo (JP); Qin Mu, Beijing (CN); Liu Liu, Beijing (CN); Huiling Jiang, Beijing (CN)

(73) Assignee: NTT DOCOMO, INC., Tokyo (JP)

(21) Appl. No.: 15/770,586

(22) PCT Filed: Jan. 6, 2017
(86) PCT No.: PCT/JP2017/000210

§ 371 Date: Apr. 24, 2018

(30) Foreign Application Priority Data
Jan. 8, 2016 (JP) 2016-003065

(51) Int. Cl. H04W 72/04

(52) U.S. Cl. CPC H04W 72/042; H04W 72/0453

(57) ABSTRACT

Provided is a user equipment that performs communication with a base station in a radio communication system in which communication is performed through a narrow band, and includes a receiving unit that receives a physical downlink control channel from the base station, the physical downlink control channel being arranged in a search space defined by one or more physical downlink control channel candidates which include all or some of a plurality of control channel elements according to a combination level, the plurality of control channel elements being set in a plurality of resources of a predetermined unit in a time direction and a decoding unit that decodes a physical downlink control channel arranged in any one of the one or more physical downlink control channel candidates in the search space.

### TECHNICAL FIELD

The present invention relates to a user equipment and a signal reception method.

### BACKGROUND ART

A specification of Long Term Evolution (LTE) for the purpose of a high speed data rate, a low delay, and the like in Universal Mobile Telecommunications System (UMTS) networks has been established (Non-Patent Document 1). Further, for the purpose to implement a wider band and a higher speed than in LTE, successor systems of LTE (for example, LTE-Advanced (LTE-A), Future Radio Access (FRA), 4G, 5G, and the like) are also under review.

Meanwhile, in recent years, with the reduction in the cost of communication devices, technology development of inter-device communication (Machine-to-Machine (M2M)) in which devices connected to a network communicate without human intervention and control automatically have been actively conducted. In particular, in Third Generation Partnership Project (3GPP), standardization related to optimization of Machine Type Communication (MTC) has been performed as a cellular system for inter-device communication in M2M (Non-Patent Document 2). In the standardization, various kinds of functions to be provided by (MTC) terminals used for MTC are also under review, and as an example, MTC terminals in which transmission/reception bandwidths are limited are under review in order to reduce the cost. As another example, since MTC terminals are likely to be arranged in the hearts of buildings or undergrounds in which building entry loss is large, and it is difficult to perform radio communication is such as the underground, MTC terminals for the purpose of coverage expansion are also under review. Based on the above two examples, terminals are classified into the following four patterns:

1. terminals in which there is no restriction to transmission/reception bandwidths and which are provided with no coverage extension function;

2. terminals in which there is a restriction to transmission/reception bandwidths and which are provided with no coverage extension function;

3. terminals in which there is no restriction to transmission/reception bandwidths and which are provided with a coverage extension function; and

4. terminals in which there is a restriction to transmission/reception bandwidths and which are provided with a coverage extension function.

MTC terminals (MTC user equipments (UEs)) are considered to be used in a wide range of fields such as electric meters, gas meters, vending machines, vehicles and other industrial devices.

### CITATION LIST

### Non-Patent Document

Non-Patent Document 1: 3GPP TS 36.300 V 12.4.0 (2014-12), “Evolved Universal Terrestrial Radio Access (E-UTRA) and Evolved Universal Terrestrial Radio Access Network (E-UTRAN); Overall description; Stage 2”
Non-Patent Document 2: 3GPP TS 36.888 V 12.0.0 (2013-06), “Study on provision of low-cost Machine-Type Communications (MTC) User Equipments (UEs) based on LTE (Release 12)”
Non-Patent Document 3: 3GPP RP-151621, “New Work Item: Narrow Band IOT (NB-IOT)”

### SUMMARY OF THE INVENTION

### Problem to be Solved by the Invention

In MTC terminals, simplifying a hardware configuration by allowing a decrease in processing capacity is under review. For example, applying lower peak rates, more limited transport block sizes, more limited resource blocks (also referred to as resource blocks (RBs) or physical resource blocks (PRBs)), more limited reception RF, and the like than in existing terminals (LTE terminals) to MTC terminals is under review.

More specifically, in Release 13 of 3GPP, for example, a review related to MTC terminals in which a lower cost is realized by limiting a use band to 180 kHz or less started (Non-Patent Document 3). A work item (WI) related to this study is called Narrow Band-Internet of Things (NB-IoT). The NB-IoT aims to realize coverage expansion of 20 dB compared to terminals of existing General Packet Radio Service (GPRS) terminals and 20 dB or more compared to terminals of a category 1 specified in existing LTE.

Here, in the 3GPP specification, user equipments in existing LTE are specified to operate to detect downlink control information (DCI) transmitted through a physical downlink control channel (PDCCH) or an enhanced physical downlink control channel (EPDCCH) through blind detection. A plurality of physical downlink control channels candidates to which the downlink control information is likely to be mapped are called a search space, and a user equipment receives the downlink control information and decodes the downlink control information by making an attempt to perform decoding (performing blind detection) on all physical downlink control channels in the search space.

In the existing LTE, since resources constituting the physical downlink control channel are closed in one subframe, the search space is also defined for each subframe. However, in NB-IoT, there is a possibility that a physical downlink control channel configuration including a plurality of resources (minimum units of radio resources used for scheduling) in the time direction is applied, and thus it is difficult to apply the search space specifying method in the existing LTE without change. Further, at this point in time, there is no search space specifying method related to NB-IoT.

The technology of the disclosure was made in light of the foregoing, and it is an object of the technology to provide a technique capable of specifying a search space in NB-IoT.

### Means for Solving Problem

A user equipment of the disclosed technology is a user equipment that performs communication with a base station in a radio communication system in which communication is performed through a narrow band, and includes a receiving unit that receives a physical downlink control channel from the base station, the physical downlink control channel being arranged in a search space defined by one or more physical downlink control channel candidates which include (or, are composed of) all or some of a plurality of control channel elements according to a combination level, the plurality of control channel elements being set in a plurality of resources of a predetermined unit in a time direction and a decoding unit that decodes a physical downlink control channel arranged in any one of the one or more physical downlink control channel candidates in the search space.

### Effect of the Invention

According to the technology of the disclosure, a technique capable of specifying a search space in NB-IoT is provided.

### BRIEF DESCRIPTION OF DRAWINGS

FIG. 1 is a diagram illustrating a radio frame structure of an EPDCCH;

FIG. 2 is a diagram illustrating an EREG grouping method in a PRB pair;

FIG. 3A is a diagram illustrating a relation among an ECCE index, a PRB pair index, and an EREG index;

FIG. 3B is a diagram illustrating a relation among an ECCE index, a PRB pair index, and an EREG index;

FIG. 4 is a diagram illustrating an exemplary setting of a use band in NB-IoT;

FIG. 5 is a diagram for describing a physical downlink control channel in NB-IoT;

FIG. 6 is a diagram illustrating an exemplary configuration of a radio communication system according to an embodiment;

FIG. 7 is a sequence diagram illustrating an example of a processing procedure of a radio communication system according to an embodiment;

FIG. 8 is a diagram for describing a method of allocating an ECCE index;

FIG. 9A is a diagram illustrating a relation among an ECCE index, a resource unit index, and an EREG index;

FIG. 9B is a diagram illustrating a relation among an ECCE index, a resource unit index, and an EREG index;

FIG. 10 is a diagram for describing a search space specifying method (2/2);

FIG. 11 is a diagram illustrating an exemplary functional configuration of a user equipment according to an embodiment; and

FIG. 12 is a diagram illustrating an exemplary hardware configuration of a user equipment according to an embodiment.

### MODE(S) FOR CARRYING OUT THE INVENTION

Hereinafter, an exemplary embodiment of the present invention will be described below with reference to the appended drawings. An embodiment to be described below is merely examples, and an embodiment to which the present invention is applied is not limited to the following embodiment. For example, a radio communication system according to an aspect of the present embodiment is assumed to be a system conforming to LTE, but the present invention is not limited to LTE and is applicable to other schemes. In this specification and the claims, “LTE” is used in a broad sense including a fifth generation communication scheme corresponding to Release 10, 11, 12, 13, 14, or later of 3GPP in addition to a communication scheme corresponding to Release 8 or 9 of 3GPP.

A base station and a user equipment according to an aspect of the present embodiment will be described as supporting a technique which is being reviewed in NB-IoT, but the present invention is not limited thereto and can be applied to various communication schemes.

In NB-IoT, a technique in which a bandwidth of one subcarrier is not limited to 15 kHz, and a bandwidth smaller than 15 kHz (for example, 3.75 kHz) is used as in existing LTE is also under review. Therefore, subcarriers used in an aspect of the present embodiment include subcarriers of bandwidths other than 15 kHz.

<Overview of EPDCCH>

(Radio Frame Configuration)

First, an overview of an EPDCCH specified in existing LTE will be described. The EPDCCH is an extended physical downlink control channel specified in Release 11 of 3GPP and specified as a control channel which is to solve deficiency in capacity of the PDCCH specified in Release 8 of 3GPP or is suitable for a multi-antenna transmission technique.

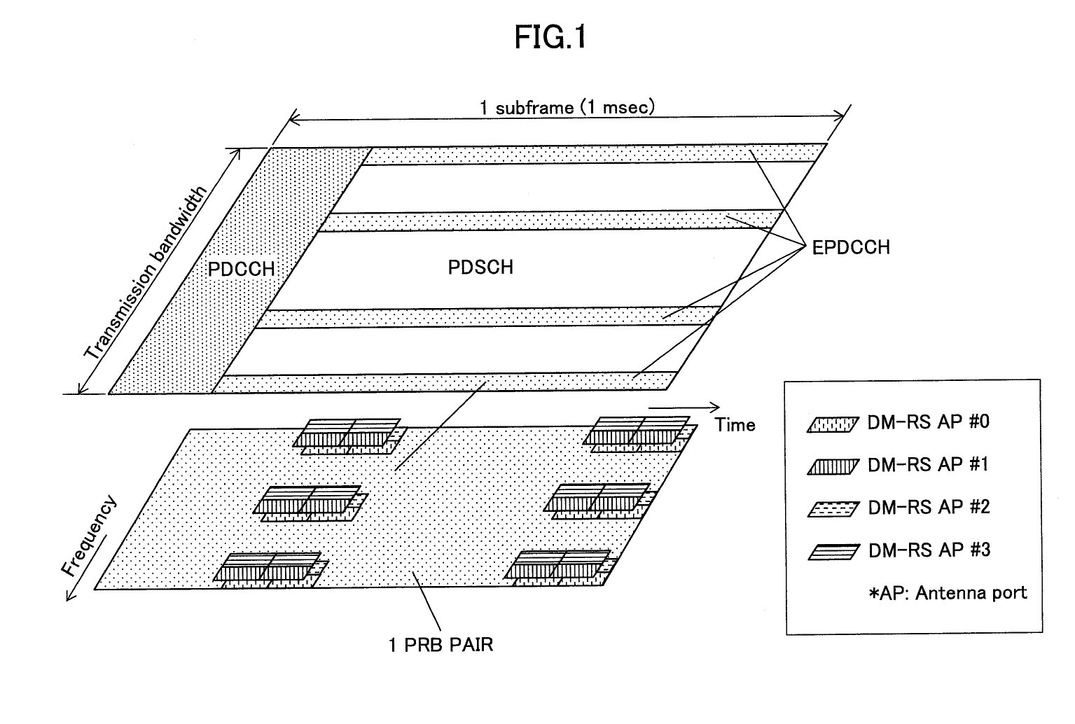

FIG. 1 is a diagram for describing a radio frame structure of an EPDCCH. The EPDCCH is multiplexed with a physical downlink shared channel (PDCCH) in units of PRBs in a frequency division manner. The number of PRB pairs used in the EPDCCH and a position of the PRB are set for each user equipment UE in an upper layer (radio resource control (RRC)).

Any one of 2, 4, and 8 PRB pairs can be set as the number of PRB pairs used in the EPDCCH. The number of PRB pairs used in the EPDCCH and the position of PRB are set according to “numberPRB-Pairs-r11” and “resourceBlockAssignment-r11” specified in TS 36.331 V 12.5.0 (2015-03) (hereinafter, referred to as “TS36.331”). FIG. 1 illustrates an example in which the number of PRB pairs used in the EPDCCH is four.

Further, it is possible to set one or two EPDCCHs for each user equipment UE. Each EPDCCH is called an EPDCCH set and identified by ID (0 or 1). Specifically, the ID is “EPDCCH-SetConfigId-r11” specified in TS 36.331. Further, it is possible to set a different number of PRB pairs for each EPDCCH set. For example, it is possible to set four PRB pairs in the EPDCCH set “ID: 0” and set eight PRB pairs in the EPDCCH set “ID: 1.”

(ECCE)

Resource elements (REs) in each of the PRB pairs used in the EPDCCH are grouped into 16 enhanced resource element groups (EREGs) of indices 0 to 15.

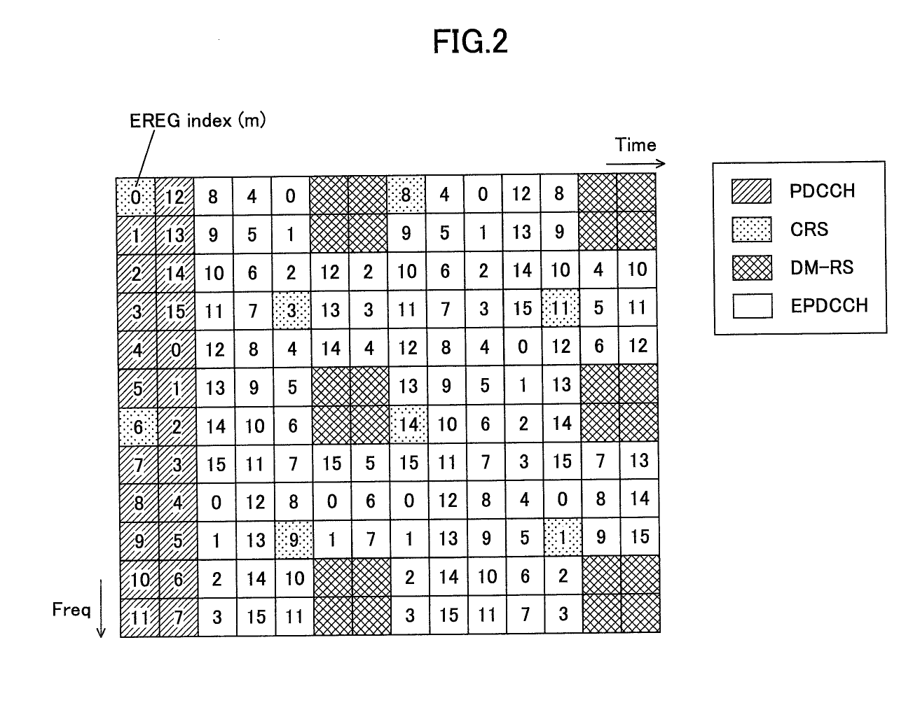

FIG. 2 is a diagram illustrating an EREG grouping method in a PRB pair. The EREG grouping method is specified in 6.2.4A of 3GPP TS 36.211 V 12.4.0 (2014-12) (hereinafter, referred to as “T536.211”), and as illustrated in FIG. 2, numbers 0 to 15 are allocated to all REs (144 REs=168−24) excluding an RE in which a demodulation reference signal (DM-RS) is transmitted in the PRB pair in an increment manner first in a frequency direction and then in a time direction. The EREGs of indices 0 to 15 include (or, are composed of) REs to which numbers 0 to 15 are allocated, respectively. For example, an EREG of an index 0 includes REs to which a number “0” is allocated in FIG. 2. Similarly, an EREG of an index 1 includes REs to which a number “1” is allocated in FIG. 2. Since 16 EREGs are specified for 144 REs in the PRB pair, each EREG includes nine REs.

EREG grouping is performed for each of the PRB pairs used in the EPDCCH. In other words, in an EPDCCH in which four PRB pairs are used (one EPDCCH set), there are four EREGs having the same index.

Then, the EPDCCH (one EPDCCH set) is transmitted using one or more enhanced control channel element (ECCE). A combination of ECCEs used when the EPDCCH (one EPDCCH set) is transmitted is decided according to an aggregation level. In the 3GPP specification, 1, 2, 4, 8, 16, and 32 are specified as aggregation levels, and a base station eNB is decided according to a data size of the DCI to be transmitted. For example, in the case of the aggregation level 1, it indicates that the EPDCCH (one EPDCCH set) is transmitted using one ECCE. Similarly, for example, in the case of the aggregation level 8, it indicates that the EPDCCH (one EPDCCH set) is transmitted using resources in which eight ECCEs are combined.

One ECCE includes four or eight EREGs as specified in Table 6.8A.1-1 of TS 36.211. Here, a method of configuring a plurality of EREGs (4 or 8 EREGs) constituting each ECCE in the EPDCCH (one EPDCCH set) with EREGs in the same PRB pair and a method of configuring a plurality of EREGs with EREGs in different PRB pairs are specified. The former is called localized transmission, and the latter is called distributed transmission. One of the localized transmission and the distributed transmission which is applied in the EPDCCH (one EPDCCH set) is set in the upper layer. Specifically, it is set according to “transmissionType-r11” specified in TS 36.331.

Each of the ECCEs in the EPDCCH (one EPDCCH set) is uniquely identified by an index (n). Here, EREGs constituting the ECCE of the index (n) are decided by the following Formula (1) in the case of the localized transmission. Further, a PRB pair index is an index which is allocated to a plurality of PRB pairs used in the EPDCCH (one EPDCCH set).starting from 0 in order in the frequency direction. For example, in the example of FIG. 1, indices 0, 1, 2, and 3 are allocated to four PRB pairs in order from the top.

$$[ Math . 1 ] \\ \begin{matrix}\begin{matrix}ECCE index n is associated with \\ PRB pair index p = ⌊ n / {N}_{ECCE}^{RB} ⌋\end{matrix} \\ EREG index m = ( n mod {N}_{ECCE}^{RB} ) + {jN}_{ECCE}^{RB}\end{matrix} \} FORMULA ( 1 )$$

$${N}_{RB}^{{X}_{m}} … Number of PRB pairs included in one EPDCCH$$

$${N}_{ECCE}^{RB} … Number of ECCEs of each PRB pair ( = 16 / {N}_{EREG}^{ECCE} )$$

$${N}_{EREG}^{ECCE} … Number of EREGs of each ECCE$$

$$j = 0 , 1 , … , {N}_{EREG}^{ECCE} - 1$$

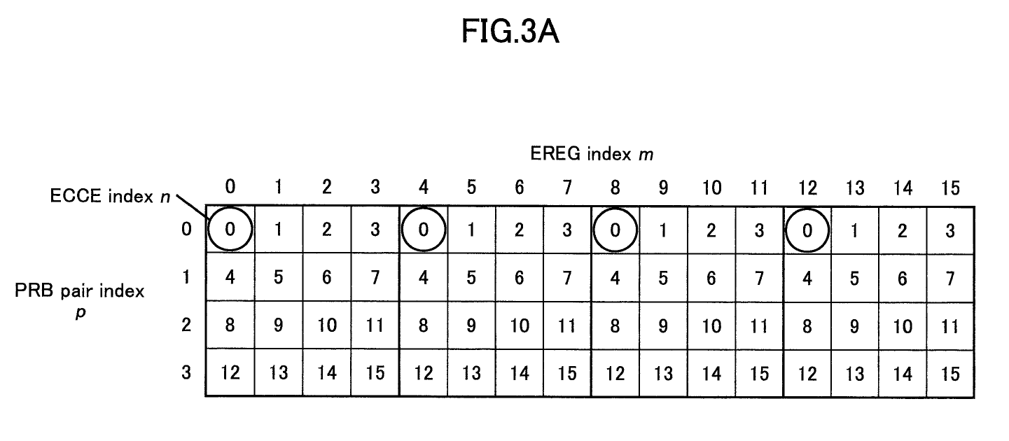

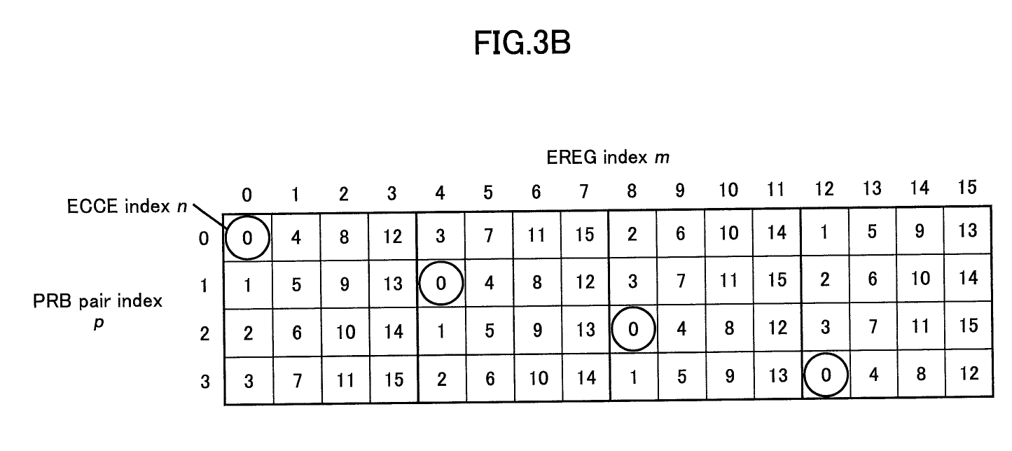

The index (p) of the PRB pair and the index (m) of the EREG decided by the formula (1) can be indicated as illustrated in FIG. 3A when four PRB pairs are used in the EPDCCH (one EPDCCH set). As illustrated in FIG. 3A, an ECCE of an index 0 includes EREGs of indices 0, 4, 8, and 12 in a PRB pair of an index 0. Similarly, an ECCE of an index 1 includes EREGs of indices 1, 5, 9, and 13 in a PRB pair of an index 0. The same applies to the ECCEs of the indices 2 to 15.

As described above with reference to FIG. 2, each EREG includes nine REs. In other words, the EREGs constituting the ECCE of the index 0 include REs having the numbers 0, 4, 8, and 12 in the PRB pair of the index 0 (more specifically, 36 REs having the numbers 0, 4, 8, and 12 illustrated in FIG. 2). The same applies to ECCEs of indices 1 to 15.

Then, in the case of the distributed transmission, the EREGs constituting the ECCE of the index “n” is decided by the following Formula (2).

$$[ Math . 2 ] \\ \begin{matrix}\begin{matrix}ECCE index n is associated with \\ PRB pair index p = ⌊ n / {N}_{RB}^{{X}_{m}} ⌋ + {jN}_{ECCE}^{RB}\end{matrix} \\ \begin{matrix}EREG index m = \\ ( n + j max ( 1 , {N}_{RB}^{{X}_{m}} / {N}_{EREG}^{ECCE} ) ) mod {N}_{RB}^{{X}_{m}}\end{matrix}\end{matrix} \} FORMULA ( 2 )$$

An index (p) of the PRB pair and an index (m) of the EREG decided by Formula (2) can be indicated as illustrated in FIG. 3B when four PRB pairs are used in the EPDCCH (one EPDCCH set). As illustrated in FIG. 3B, an ECCE of an index 0 includes an EREG of an index 0 in a PRB pair of an index 0, an EREG of an index 4 in a PRB pair of an index 1, an EREG of an index 8 in a PRB pair of an index 2, and an EREG of an index 12 in a PRB pair of an index 3. Similarly, an ECCE of an index 1 includes an EREG of an index 0 in a PRB pair of an index 1, an EREG of an index 4 in a PRB pair of an index 2, an EREG of an index 8 in a PRB pair of an index 3, and an EREG of an index 12 in a PRB pair of an index 0. The same applies to ECCEs of indices 2 to 15.

(Search Space)

As described above, a combination of ECCEs used when the EPDCCH (one EPDCCH set) is transmitted is decided according to the aggregation level. Theoretically, all ECCE combination patterns can be considered for each aggregation level. For example, in the case of the aggregation level 4, it is possible to combine the ECCEs of the indices 1, 2, 9, and 15, or it is possible to combine the ECCEs of the indices 5, 6, 9, and 15.

Here, since the base station eNB decides the aggregation level for each subframe according to the data size of the DCI to be transmitted or the quality of a radio propagation path, the user equipment UE is unable to detect the aggregation level in advance. Therefore, when the user equipment UE receives the EPDCCH (that is, when the user equipment UE receives the DCI), it is necessary to make an attempt to perform blind detection on ECCE combinations corresponding to all the aggregation levels. In this case, the user equipment UE makes an attempt to perform the blind detection on huge amounts of ECCE combination patterns, and thus a processing load of the user equipment UE becomes enormous.

In this regard, a mechanism of suppressing the processing load of the user equipment UE by restricting the ECCE combination patterns on which the user equipment UE makes an attempt to perform the blind detection for each aggregation level in advance has been introduced. The ECCE combination patterns on which the user equipment UE makes an attempt to perform the blind detection for each aggregation level (the ECCE combination pattern is also referred to as an “EPDCCH candidate”) are referred to as a “search space.” The search space is decided for each EPDCCH set according to the following Formula (3) and differs according to each subframe. A specific number of the “number of EPDCCH candidates in an aggregation level L” in Formula (3) is specified in Table 9.1.4 of 3GPP TS 36.213 V 12.4.0 (2014-12) (hereinafter, referred to as “TS36.213”). RNTI (C-RNTI, SPS C-RNTI, or the like) allocated to the user equipment UE is set as a value (n_{RNTI}) of a radio network temporary identifier (RNTI). A total of the number of ECCEs included in all PRB pairs used in the EPDCCH (one EPDCCH set) is set as “N_{ECCE,k}.” For example, in the case of the EPDCCH using four PRB pairs, a total of the number of ECCEs is 16 as illustrated in FIGS. 3A and 3B.

$$[ Math . 3 ] \\ \begin{matrix}Search space of subframe k ( ECCE index n ) = \\ L \{ ( {Y}_{k} + ⌊ \frac{m \cdot {N}_{ECCE , k}}{L \cdot {M}^{( L )}} ⌋ ) mod ⌊ {N}_{ECCE , k} / L ⌋ \} + i \\ {Y}_{k} = ( A \cdot {Y}_{k - 1} ) mod D A = 39827 D = 65537 \\ {Y}_{- 1} = {n}_{RNTI}\end{matrix} \} FORMULA ( 3 )$$

$$k … Subframe number$$

$$L … Aggregation level$$

$$i = 0 , 1 , … , L - 1$$

$${N}_{ECCE , k} … Number of ECCEs included in PRB pairs constituting$$

$$one EPDCCH set of subframe k$$

$${M}^{( L )} … Number of EPDCCH candidates in aggregation level L$$

$$m = 0 , 1 , … , {M}^{( L )} - 1$$

$${n}_{RNTI} … RNTI value$$

When the base station eNB transmits the DCI through a predetermined subframe, the base station eNB maps the DCI with any one of all ECCE combination patterns (all EPDCCH candidates) included in the search space obtained by Formula (3) and then transmits a resulting signal. When the user equipment UE receives the DCI through a predetermined subframe, the user equipment UE detects the search space in a predetermined subframe using Formula (3), makes an attempt to perform the blind detection on all the ECCE combination patterns (all the EPDCCH candidates) included in the search space, and then acquires the DCI.

<Overview of NB-IoT>

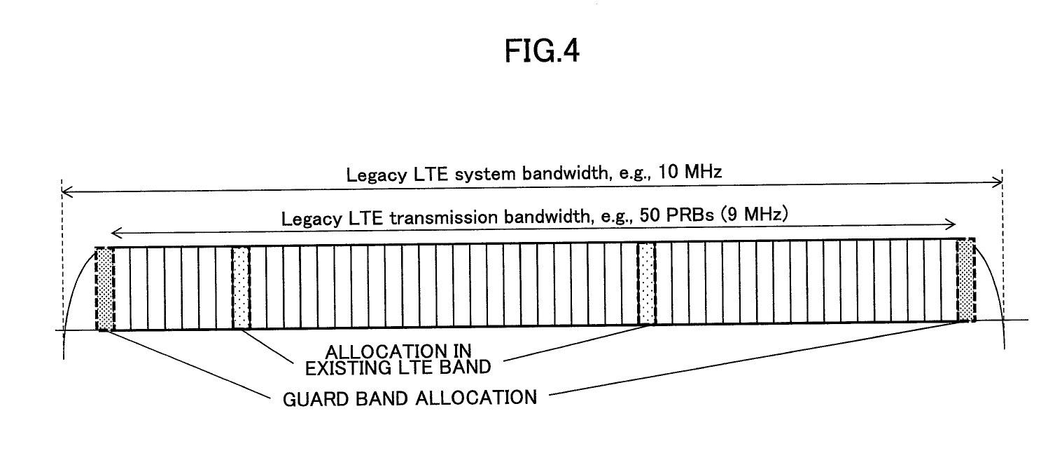

Next, an overview of NB-IoT will be described. In NB-IoT, three scenarios are under review as a use band arrangement method. A first scenario is a scenario in which one of bands (for example, 9 MHz) actually usable for transmission and reception in an LTE system band (for example, 10 MHz) is set as a use band, and a second scenario is a scenario in which a band corresponding to a guard band in an LTE system band is set as a use band, and a third scenario is a scenario in which a band dedicated to NB-IoT is used. FIG. 4 illustrates an exemplary setting of a use band in the first and second scenarios.

In existing LTE, scheduling is performed in units PRB pairs (one TTI) using PRBs (each of which includes 12 subcarriers and one slot) as units of radio resources (one transport block (1 TB) is mapped to resources of one PRB pair). On the other hand, in NB-IoT, since a use band is narrow, specifying resource units different from PRBs and PRB pairs is under review. For example, there are an idea in which resources including one subcarrier and 12 subframes are used as resource units, an idea in which resource including six subcarriers and six subframes are used as resource units, and the like. Further, an idea in which the same unit (a PRB or a PRB pair) as in existing LTE is applied without change is also under review. In addition, an idea in which a resource size to which 1 TB can be mapped (corresponding to a PRB pair in existing LTE) is used as a resource unit and an idea in which a resource size in which 1 TB is transmitted through a plurality of resource units (which is close to a PRB in existing LTE) have been proposed. In this regard, in the following description, resources which are minimum units of radio resources used for scheduling and including, for example, one or more subframes (or one or more slots) in the time direction and 1 to 12 subcarriers in the frequency direction are referred to as “resource units (unit resources)” for convenience. A name of the “resource unit” is not limited thereto, and other names may be used.

In NB-IoT, since the use band is narrow, radio resources in the frequency direction are small. In this regard, in order to secure a data size that can be mapped to the physical downlink control channel, a physical downlink control channel configuration including a plurality of resource units is assumed to be applied.

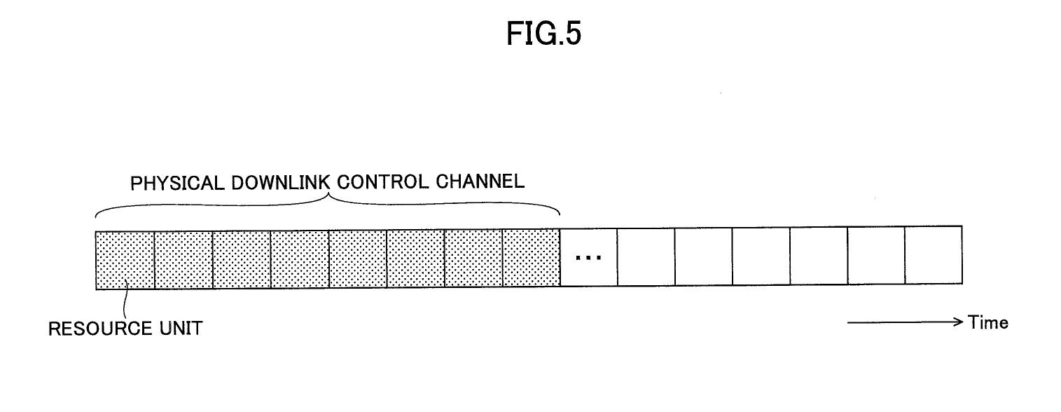

FIG. 5 is a diagram illustrating an exemplary configuration of a physical downlink control channel assumed in NB-IoT. The physical downlink control channel illustrated in FIG. 5 illustrates an example in which eight resource units are included.

<System Configuration>

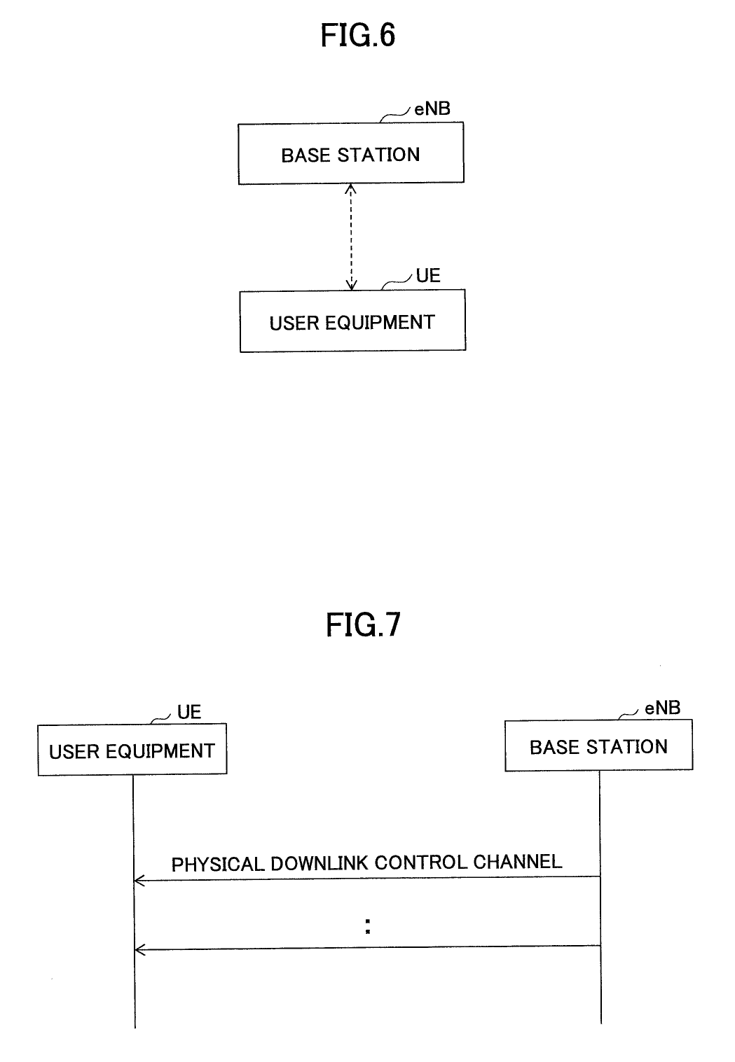

FIG. 6 is a diagram illustrating an exemplary configuration of a radio communication system according to an embodiment. As illustrated in FIG. 6, a radio communication system according to the present embodiment includes a base station eNB and a user equipment UE. In the example of FIG. 6, one base station eNB and one user equipment UE are illustrated, but a plurality of base stations eNB or a plurality of user equipments UE may be provided.

The base station eNB and the user equipment UE perform DL (Downlink) communication and UL (Uplink) communication using a predetermined band (for example, 180 kHz). As described above, the predetermined band may be any one of bands that can actually be used for transmission and reception in the LTE system band, may be a band corresponding to a guard band in the LTE system band, or may be a band dedicated to NB-IoT. Further, the predetermined band may be a band that differs according to each user equipment UE.

In an aspect of the present embodiment, transmission and reception of the physical downlink control channel used for transmission of the downlink control information (DCI) are assumed to be performed within a predetermined band. Further, the physical downlink control channel according to an aspect of the present embodiment is assumed to include a plurality of resource units. The physical downlink control channel according to an aspect of the present embodiment may be referred to as a “PDCCH,” may be referred to as an “MTC PDCCH (MPDCCH),” or may be referred to as a “narrow band PDCCH (NB-PDCCH)”. The present invention is not limited thereto, and other names may be used.

The base station eNB may be configured to support a communication scheme in existing LTE or may be configured to support only functions related to NB-IoT. The user equipment UE may be referred to as an “NB-IoT terminal,” may be referred to as an “MTC terminal,” or may be referred to as a “user equipment UE” in which a band to be supported is limited.

In the following description, terms “aggregation level” and “search space” are used to have the same meaning as existing LTE. In addition, “ECCE” and “EREG” used in the following description are not limited thereto and used as a meaning including other names (for example, M-CCE, M-REG, NB-CCE, NB-REG, a control channel element, a resource element group, and the like) specified in NB-IoT.

<Processing Sequence>

FIG. 7 is a sequence diagram illustrating an example of a processing procedure of the radio communication system according to an embodiment. The base station eNB decides an appropriate aggregation level according to the size of the downlink control information (DCI) to be transmitted to the user equipment UE or the quality of the radio propagation path, maps the downlink control information (DCI) to a physical downlink control channel candidate corresponding to the decided aggregation level among all physical downlink control channel candidates included in the search space specified according to an aspect of the present embodiment, and transmits a signal of the physical downlink control channel (S11).

The user equipment UE makes an attempt to perform the blind detection on all the physical downlink control channel candidates included in the search space specified according to an aspect of the present embodiment, and receives the physical downlink control channel transmitted from the base station eNB (acquires the downlink control information (DCI)).

<Search Space Specifying Method>

Next, a search space specifying method (1/2) and a search space specifying method (2/2) will be described as a method of specifying the search space in the physical downlink control channel used in an aspect of the present embodiment. The search space specified according to an aspect of the present embodiment is based on a method of specifying the search space in the PDCCH and the EPDCCH according to the related art.

In an aspect of the present embodiment, the base station eNB and the user equipment UE may use only one of the search space specifying method (1/2) and the search space specifying method (2/2), or an instruction may be given from the base station eNB to the user equipment UE through the upper layer (RRC, broadcast information, or the like).

[Search Space Specifying Method (1/2)]

In the search space specifying method (1/2), similarly to the EPDCCH, one ECCE is used as a minimum unit of the physical downlink control channel, and combination patterns of ECCEs on which the user equipment UE makes an attempt to perform the blind detection for each aggregation level are specified as the search space.

Further, the search space is specified by converting a method of allocating an ECCE index in the EPDCCH from the frequency domain to the time domain and diverting the method of allocating an ECCE index in the EPDCCH.

(ECCE Index Allocation Method)

First, a method of allocating an ECCE index in the search space specifying method (1/2) will be described.

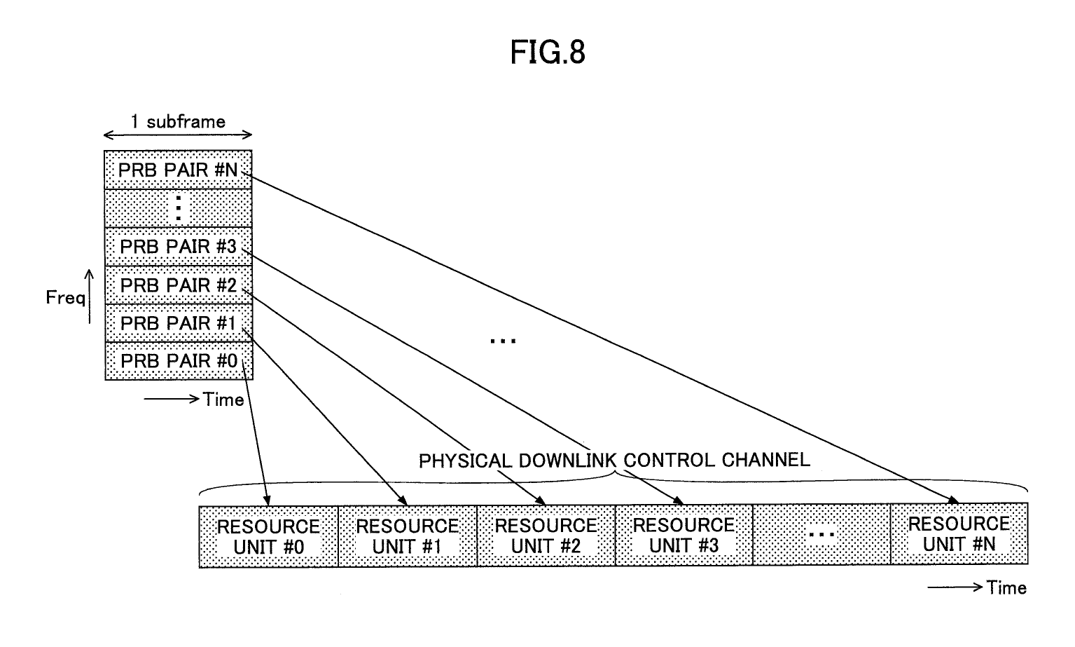

FIG. 8 is a diagram for describing a method of allocating an ECCE index. As described above, in the EPDCCH, indices are assigned to a plurality of PRB pairs starting from 0 in order in the frequency direction. An example on an upper left of FIG. 8 illustrates indices (p=0 to N) assigned to PRB pairs in the EPDCCH.

Since the physical downlink control channel according to an aspect of the present embodiment includes a plurality of resource units in the time direction, in the search space specifying method (1/2), indices (q=0 to N) are allocated to a plurality of resource units starting from 0 in order in the time direction as illustrated in an example on a lower right side of FIG. 8. As described above, an index is allocated to each resource unit, and a resource unit is further regarded as a PRB pair in the EPDCCH, and thus it is possible to divert the aforementioned Formula (1) and Formula (2) in the search space specifying method (1/2).

More specifically, when Formula (1) is diverted, an EREG index and a resource unit index constituting an ECCE are decided using Formula (4) in which the “index (p) of the PRB pair” in Formula (1) is replaced with the “index (q) of the resource unit.” The number of EREGs of each ECCE in Formula (4) may not be the same as that in the EPDCCH. In other words, in the EPDCCH, the number of EREGs of each ECCE is either 4 or 8, but in an aspect of the present embodiment, a predetermined number which is determined in advance in a standard specification of NB-IoT or the like is set.

$$[ Math . 4 ] \\ \begin{matrix}\begin{matrix}ECCE index n is associated with \\ resource unit index q = ⌊ n / {N}_{ECCE}^{RB} ⌋\end{matrix} \\ EREG index m = ( n mod {N}_{ECCE}^{RB} ) + {jN}_{ECCE}^{RB}\end{matrix} \} FORMULA ( 4 )$$

$${N}_{RB}^{{X}_{m}} … Number of resource units included in physical downlink$$

$$control channel$$

$${N}_{ECCE}^{RB} … Number of ECCEs of each resource unit ( = 16 / {N}_{EREG}^{ECCE} )$$

$${N}_{EREG}^{ECCE} … Number of EREGs of each ECCE$$

$$j = 0 , 1 , … , {N}_{EREG}^{ECCE} - 1$$

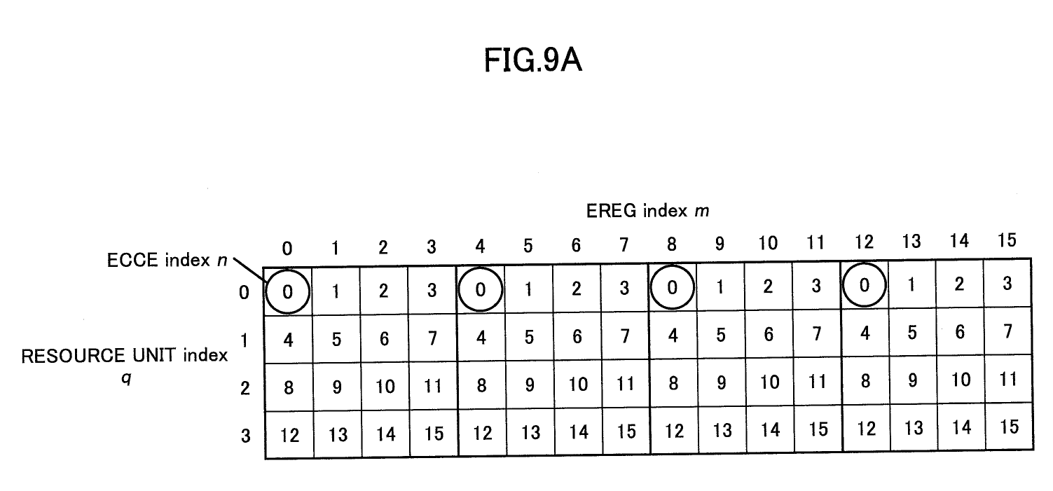

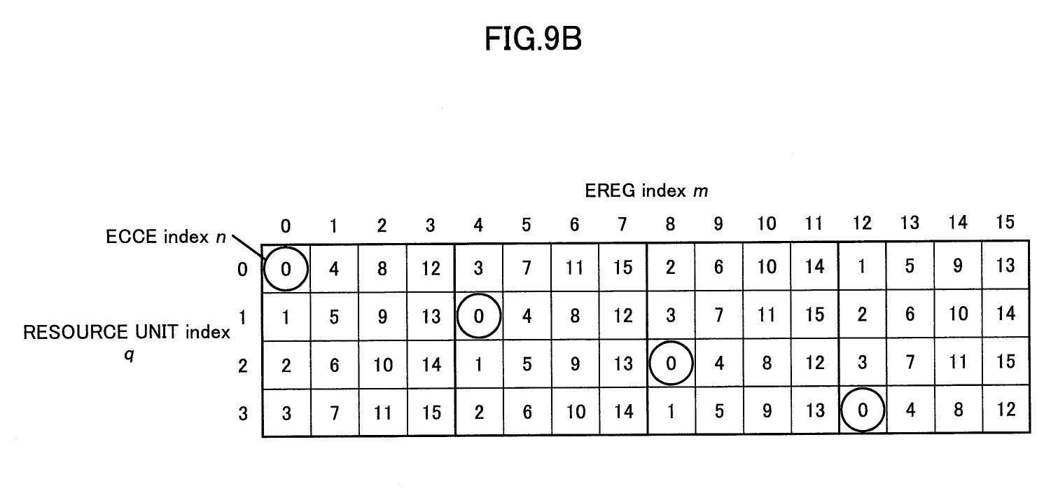

The index (q) of the resource unit and the index (m) of EREG decided by Formula (4) can be indicated as illustrated in FIG. 9A when the physical downlink control channel includes four resource units.

As illustrated in FIG. 9A, an ECCE of an index 0 includes EREGs of indices 0, 4, 8, and 12 in a resource unit of an index 0. Similarly, an ECCE of an index 1 includes EREGs of indices 1, 5, 9, and 13 in a resource unit of index 0. The same applies to ECCEs of indices 2 to 15.

When Formula (4) is used, each ECCE includes EREGs in the same resource unit. In other words, it corresponds to the localized transmission in the EPDCCH.

Similarly, when Formula (2) is diverted, an EREG index and a resource unit index constituting an ECCE are decided using Formula (5) in which the “index (p) of the PRB pair” in Formula (2) is replaced with the “index (q) of the resource unit.”

$$[ Math . 5 ] \\ \begin{matrix}\begin{matrix}ECCE index n is associated with \\ resource unit index q = ⌊ n / {N}_{RB}^{{X}_{m}} ⌋ + {jN}_{ECCE}^{RB}\end{matrix} \\ EREG index m = \\ ( n + j max ( 1 , {N}_{RB}^{{X}_{m}} / {N}_{EREG}^{ECCE} ) ) mod {N}_{RB}^{{X}_{m}}\end{matrix} \} FORMULA ( 5 )$$

The index (q) of the resource unit and the index (m) of the EREG decided by Formula (5) can be indicated as illustrated in FIG. 9B when the physical downlink control channel includes four resource units.

As illustrated in FIG. 9B, an ECCE of an index 0 includes an EREG of an index 0 in a resource unit of an index 0, an EREG of an index 4 in a resource unit of an index 1, an EREG of an index 8 in a resource unit of an index 2, and an EREG of an index 12 in a resource unit of an index 3. Similarly, an ECCE of an index 1 includes an EREG of an index 0 in a resource unit of an index 1, an EREG of an index 4 in a resource unit of an index 2, an EREG of an index 8 in a resource unit of an index 3, and an EREG of an index 12 in a resource unit of an index 0. The same applies to ECCEs of indices 2 to 15.

When Formula (5) is used, each ECCE includes EREGs which are distributed over a plurality of resource units (that is, includes EREGs which are distributed in the time direction). In other words, it corresponds to the distributed transmission in the EPDCCH.

In the search space specifying method (1/2), only one of Formulas (4) and (5) may be used, or an instruction may be given from the base station eNB to the user equipment UE through the upper layer (RRC, broadcast information, or the like).

(EREG)

The physical downlink control channel according to an aspect of the present embodiment includes “resource units” rather than “PRB pairs.” In other words, an RE configuration in the “resource unit” may be different from an RE configuration in the PRB pair according to the related art (FIG. 2).

In this regard, in the search space specifying method (1/2), EREG grouping is performed on REs in the “resource unit” by diverting the EREG grouping method in the EPDCCH.

More specifically, numbers of 0 to 15 are allocated to all REs excluding an RE in which the DM-RS is transmitted in one resource unit in an increment manner first in the frequency direction and then in the time direction. Further, the EREGs of indices 0 to 15 include REs to which numbers of 0 to 15 are allocated, respectively. Since the number of REs in the resource unit is assumed to be different from the number of REs in the PRB pair, the number of REs constituting each EREG is not limited to nine as in the EPDCCH. The present invention is not limited thereto, and REs may be grouped using other methods.

EREG grouping is performed for each resource unit included in the physical downlink control channel. In other words, in the case of the physical downlink control channel including four resource units, there are four EREGs having the same index.

(Search Space)

In the search space specifying method (1/2), the search space is decided by diverting Formula (3) used for deciding the search space in the EPDCCH. Specifically, in the search space specifying method (1/2), the search space is decided by the following Formula (6).

$$[ Math . 6 ] \\ \begin{matrix}\begin{matrix}Search space ( ECCE index n ) = \\ L \{ ( {Y}_{k} + ⌊ \frac{m \cdot {N}_{ECCE , k}}{L \cdot {M}^{( L )}} ⌋ ) mod ⌊ {N}_{ECCE , k} / L ⌋ \} + i\end{matrix} \\ {Y}_{k} = ( A \cdot {Y}_{k - 1} ) mod D A = 39827 D = 65537 \\ {Y}_{- 1} = {n}_{RNTI}\end{matrix} \} FORMULA ( 6 )$$

$$L … Aggregation level$$

$$i = 0 , 1 , … , L - 1$$

$${N}_{ECCE , k} … Number of ECCEs included in all resource units$$

$$constituting physical downlink control channel$$

$${M}^{( L )} … Number of physical downlink control channel candidates in$$

$$aggregation level L$$

$$m = 0 , 1 , … , {M}^{( L )} - 1$$

$${n}_{RNTI} … RNTI value$$

A value set to the aggregation level in Formula (6) may not be the same as that in the EPDCCH. In other words, 1, 2, 4, 8, 16, and 32 are specified as the aggregation level in the EPDCCH, but in an aspect of the present embodiment, an arbitrary aggregation level which is decided in advance in the standard specification of NB-IoT or the like is set. For a specific number of the “number of physical downlink control channel candidates in the aggregation level L,” a predetermined number which is predetermined in advance in a standard specification or the like is set. A predetermined RNTI which is predetermined in advance in a standard specification of NB-IoT or the like and allocated to the user equipment UE is set as a value (n_{RNTI}) of an RNTI. A total of the number of ECCEs included in all resource units used in the physical downlink control channel is set as “N_{ECCE,k}.” For example, in the case of the physical downlink control channel using four resource units, a total of the number of ECCEs is 16 as illustrated in FIGS. 9A and 9B.

Here, in the EPDCCH, since the search space is decided for each subframe, a value of “k” is the subframe number. On the other hand, the physical downlink control channel according to an aspect of the present embodiment is likely to include a plurality of subframes. In this regard, in the search space specifying method (1/2), as the value of “k,” a subframe number of a subframe in which a head resource unit (a first resource unit on a time axis) is included in the physical downlink control channel (a start subframe number) may be set, a value decided by the following Formula (7) may be set, or 0 or an arbitrary positive integer may be set. Further, an “SFN” in Formula (7) indicates a system frame number of the head resource unit in the physical downlink control channel.

$$\begin{matrix}[ Math . 7 ] & \\ k = floor ( \frac{SFN * 10 + Start subframe number}{\begin{matrix}Number of resource units in \\ physical downlink control channel\end{matrix}} ) & FORMULA ( 7 )\end{matrix}$$

[Search Space Specifying Method (2/2)]

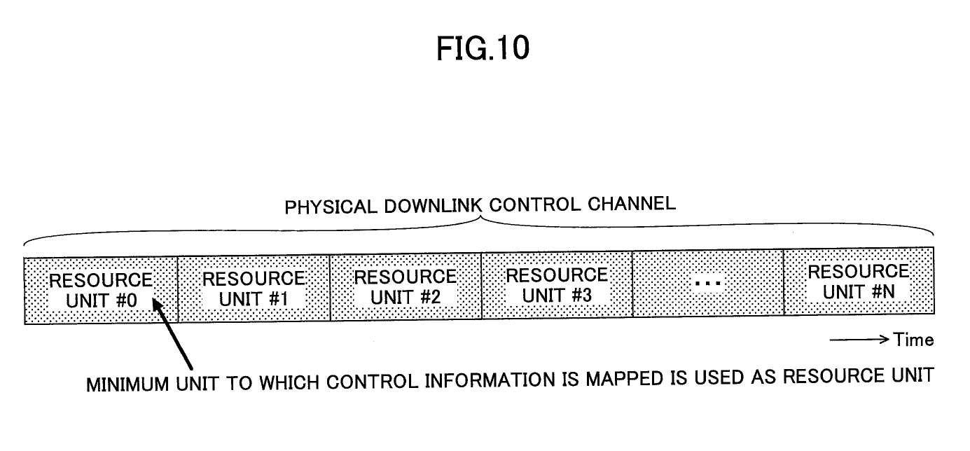

FIG. 10 is a diagram for describing the search space specifying method (2/2). Unlike the search space specifying method (1/2), in the search space specifying method (2/2), one resource unit is used as a minimum unit of the physical downlink control channel, and a combination pattern of resource units on which the user equipment UE makes an attempt to perform the blind detection for each aggregation level is specified as the search space.

Specifically, for example, in the case of the aggregation level 1, the downlink control information (DCI) is mapped to one resource unit. Similarly, in the case of the aggregation level 5, the downlink control information (DCI) is mapped to resources in which five resource units are combined.

In the search space specifying method (2/2), a method of allocating indices to resource units is the same as in the search space specifying method (1/2).

(Search Space)

In the search space specifying method (2/2), the search space is decided by the following Formula (8).

$$[ Math . 8 ] \\ \begin{matrix}\begin{matrix}Search space ( resource unit index q ) = \\ N \{ ( {Y}_{k} + m ) mod ⌊ {N}_{RB}^{X} / N ⌋ \} + i\end{matrix} \\ {Y}_{k} = ( A \cdot {Y}_{k - 1} ) mod D A = 39827 D = 65537 \\ {Y}_{- 1} = {n}_{RNTI}\end{matrix} \} FORMULA ( 8 )$$

$$N … Aggregation level$$

$$i = 0 , 1 , … , N - 1$$

$$m = 0 , 1 , … , {M}_{N}$$

$${M}_{N} … Number of physical downlink control channel candidates in$$

$$aggregation level N$$

$${N}_{RB}^{X} … Number of resource units constituting physical downlink$$

$$control channel$$

$$k … SFN of first resource unit constituting physical downlink$$

$$control channel$$

In Formula (8), a value set as the aggregation level, a specific number of the “number of physical downlink control channel candidates in the aggregation level N”, and a RNTI value (n_{RNTI}) may be predetermined values/numbers which are predetermined in advance in the standard specification of NB-IoT or the like, similarly to the search space specifying method (1/2). As the value of “k”, the system frame number in the subframe (starting subframe) including the head resource unit (the first resource unit on the time axis) in the physical downlink control channel is set. Incidentally, the value of “k” is not limited thereto, and 0 or an arbitrary positive integer may be set.

[Supplemental Matters]

The search space according to an aspect of the present embodiment may be a UE specific search space as in the EPDCCH or may include a UE specific search space and a common search space as in the PDCCH. The UE specific search space indicates a search space which is set to be specific to each user equipment UE in order to perform scheduling of user data mainly, and the common search space indicates a search space which is set to be common to all the user equipments UE in order to transmit paging and RACH responses mainly.

The common search space may be implemented, for example, by setting an RNTI common to all the user equipments UE as the RNTI value (n_{RNTI}) in Formulas (6) and (8) when the common search space is set. As another method, in the search space specifying method (1/2), a specific ECCE (for example, ECCEs of indices 0 to 3 or the like) may be set as the common search space. Further, in the search space specifying method (2/2), a specific resource unit (for example, a resource unit of an index 0) may be set as the common search space.

An exemplary functional configuration of the user equipment UE that performs the above-described processing procedure will be described.

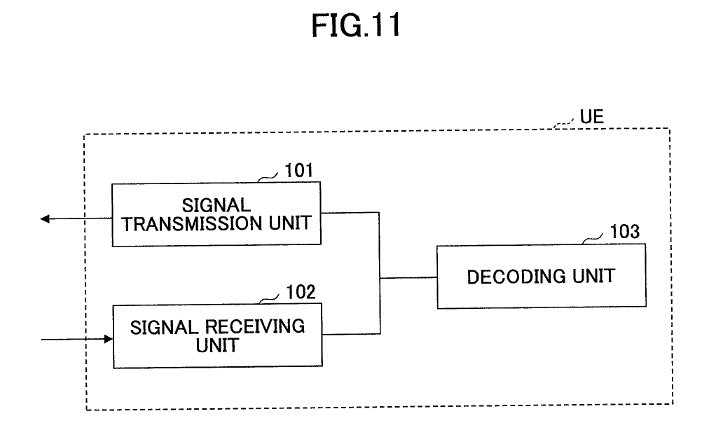

FIG. 11 is a diagram illustrating an exemplary functional exemplary configuration of the user equipment according to an embodiment. As illustrated in FIG. 11, the user equipment UE includes a signal transmitting unit 101, a signal receiving unit 102, and a decoding unit 103. FIG. 11 illustrates only functional portions which are particularly related to an embodiment of the present invention in the user equipment UE and include functions (not illustrated) for performing at least an operation conforming to LTE. The functional configuration illustrated in FIG. 11 is merely an example. Any function classification or any name can be used as a function classification or names of the function portions as long as an operation according to an aspect of the present embodiment can be performed.

The signal transmitting unit 101 has a function of generating various kinds of signals to be transmitted from the user equipment UE and transmitting the signals wirelessly. The signal receiving unit 102 has a function of receiving various kinds of radio signals from the base station eNB. Each of the signal transmitting unit 101 and the signal receiving unit 102 is assumed to include a packet buffer and perform processing of layer 1 (PHY), layer 2 (MAC, RLC, PDCP), and layer 3 (RRC) (but, the preset invention is not limited thereto).

Further, the signal receiving unit 102 has a function of receiving a signal of the physical downlink control channel which is arranged in the search space defined by one or more physical downlink control channel candidates which include all or some of a plurality of ECCEs set in a plurality of resource units in the time direction according to the aggregation level.

Further, the signal receiving unit 102 has a function of receiving a signal of the physical downlink control channel which is arranged in the search space defined by one or more physical downlink control channel candidates which include all or some of a plurality of resource units in the time direction according to the aggregation level.

The decoding unit 103 has a function of decoding a signal of the physical downlink control channel arranged in any one of one or more physical downlink control channel candidates in the search space (acquiring the downlink control information (DCI)).

The entire functional configuration of the user equipment UE described above may be implemented by a hardware circuit (for example, one or a plurality of IC chips), a part of the functional configuration of the user equipment UE may include a hardware circuit, and the remaining parts may be implemented by a CPU and a program.

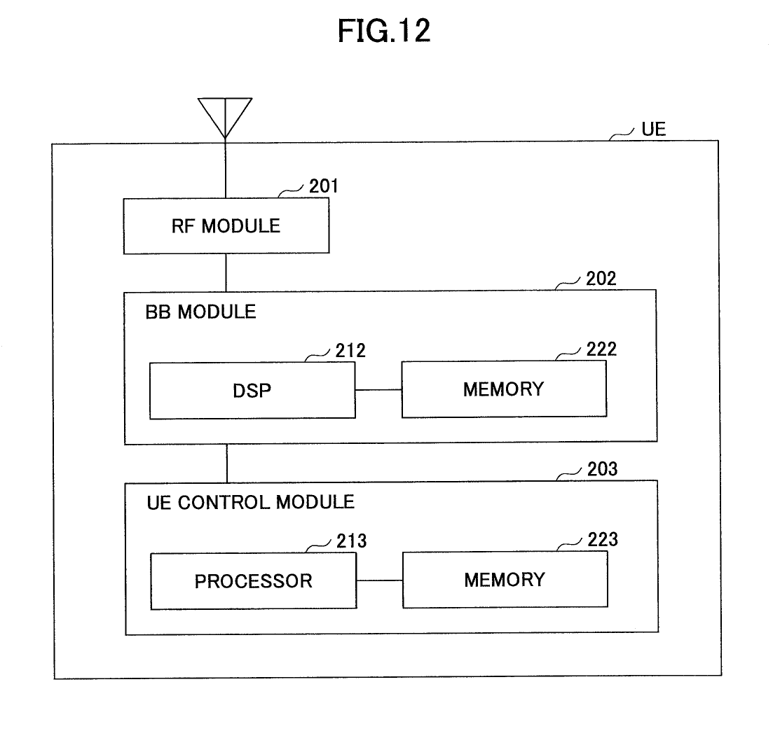

FIG. 12 is a diagram illustrating an exemplary hardware configuration of the user equipment according to an embodiment. FIG. 12 illustrates a configuration that is closer to an implementation example than that of FIG. 11. As illustrated in FIG. 12, the user equipment UE includes an RF module 201 that performs processing related to radio signals, a BB processing module 202 that performs baseband signal processing, and a UE control module 203 that performs processing of an upper layer or the like.

The RF module 201 performs D/A conversion, modulation, frequency transform, power amplification, and the like on digital baseband signals received from the BB processing module 202 and generates radio signals to be transmitted from the antenna. Further, the RF module 201 performs frequency transform, A/D conversion, demodulation, and the like on received radio signals, generates digital baseband signals, and transfers the digital baseband signal to the BB processing module 202. The RF module 201 includes, for example, a part of the signal transmitting unit 101 and a part of the signal receiving unit 102 illustrated in FIG. 11.

The BB processing module 202 performs a process of mutually converting IP packets and digital baseband signals. A DSP 212 is a processor that performs signal processing in the BB processing module 202. A memory 222 is used as a work area of the DSP 212. The BB processing module 202 includes, for example, a part of the signal transmitting unit 101, a part of the signal receiving unit 102, and the decoding unit 103 illustrated in FIG. 11.

The UE control module 203 performs protocol processing of an IP layer, processing of various kinds of applications, and the like. A processor 213 is a processor that performs processing which is performed by the UE control module 203. A memory 223 is used as a work area of the processor 213. The UE control module 203 includes, for example, a part of the signal transmitting unit 101 and a part of the signal receiving unit 102 illustrated in FIG. 11.

### CONCLUSION

As described above, according to the embodiment, provided is a user equipment that performs communication with a base station in a radio communication system in which communication is performed through a narrow band, and includes a receiving unit that receives a physical downlink control channel from the base station, the physical downlink control channel being arranged in a search space defined by one or more physical downlink control channel candidates which include all or some of a plurality of control channel elements according to a combination level, the plurality of control channel elements being set in a plurality of resources of a predetermined unit in a time direction and a decoding unit that decodes a physical downlink control channel arranged in any one of the one or more physical downlink control channel candidates in the search space. A technique of specifying the search space in NB-IoT is provided through the user equipment UE.

Each of the plurality of control channel elements may include a plurality of resource element groups, and the plurality of resource element groups may be distributed in the plurality of resources. Thus, it is possible to cause the resource elements constituting the control channel element to be distributed in the time direction.

Each of the plurality of control channel elements may include a plurality of resource element groups, and each of the plurality of resource element groups may be arranged in a specific resource in the plurality of resources. Accordingly, it is possible to prevent the resource elements constituting the control channel element from being distributed in the time direction, and it is possible to suppress influence of channel fluctuation or the like which is caused by the passage of time.

Further, according to the embodiment, provided is a user equipment that performs communication with a base station in a radio communication system in which communication is performed through a narrow band, and includes a receiving unit that receives a physical downlink control channel from the base station, the physical downlink control channel being arranged in a search space defined by one or more physical downlink control channel candidates which include all or some of a plurality of resources of a predetermined unit in a time direction according to a combination level and a decoding unit that decodes a physical downlink control channel arranged in any one of the one or more physical downlink control channel candidates in the search space. A technique of specifying the search space in NB-IoT is provided through the user equipment UE.

The narrow band may be a frequency band of 180 kHz, and the resource may be a resource including one or more subframes or one or more slots and 1 to 12 subcarriers.

Further, according to the embodiment, provided is a signal reception method performed by a user equipment that performs communication with a base station in a radio communication system in which communication is performed through a narrow band, and includes a step of receiving a physical downlink control channel from the base station, the physical downlink control channel being arranged in a search space defined by one or more physical downlink control channel candidates which include all or some of a plurality of control channel elements according to a combination level, the plurality of control channel elements being set in a plurality of resources of a predetermined unit in a time direction and a step of decoding a physical downlink control channel arranged in any one of the one or more physical downlink control channel candidates in the search space. A technique of specifying the search space in NB-IoT is provided through the signal reception method.

Further, according to the embodiment, provided is a signal reception method performed by a user equipment that performs communication with a base station in a radio communication system in which communication is performed through a narrow band, and includes a step of receiving a physical downlink control channel from the base station, the physical downlink control channel being arranged in a search space defined by one or more physical downlink control channel candidates which include all or some of a plurality of resources of a predetermined unit in a time direction according to a combination level and a step of decoding a physical downlink control channel arranged in any one of the one or more physical downlink control channel candidates in the search space. A technique of specifying the search space in NB-IoT is provided through the signal reception method.

### SUPPLEMENT TO EMBODIMENT

Reception of the physical downlink control channel may be expressed as reception of the signal of the physical downlink control channel. Further, decoding of the physical downlink control channel may be expressed as decoding of the signal of the physical downlink control channel.

As described above, each of the devices (the user equipment UE and the base station eNB) described in the embodiment of the present invention may have a configuration which is implemented by executing a program through the CPU (the processor) in the device including the CPU and the memory, a configuration in which is implemented by hardware such as a hardware circuit equipped with a logic of processing described in the aspect of the present embodiment, or a configuration including a combination of a program and hardware.

The embodiment of the present invention has been described above, but the disclosed invention is not limited to such embodiment, and those skilled in the art would understand various modifications, changes, alternatives, substitutions, and the like. The description has been made using specific numerical examples in order to facilitate understanding of the invention, but unless otherwise specified, the numerical values are merely examples, and any suitable value may be used. The classification of sections in the above description is not essential to the present invention, and matters described in two or more sections may be combined and used as necessary, and matters described in one section may be applied to matters described in another section (unless inconsistent). The boundary of the functional unit or the processing unit in the functional block diagram does not necessarily correspond to the boundary of the physical component. Operation of a plurality of functional units may be performed physically through one component, or an operation of one functional unit may be performed physically through a plurality of components. The sequences and the flowcharts described in the embodiment may be interchanged as long as there is no inconsistency. For convenience of processing description, the user equipment UE and the base station NB have been described using the functional block diagrams, but such devices may be implemented by hardware, software, or a combination thereof. Software operated by the processor included in the user equipment UE according to the embodiment of the present invention and software operated by the processor included in the base station eNB according to the embodiment of the present invention may be stored in a random access memory (RAM), a flash memory, a read only memory (ROM), an EPROM, an EEPROM, a register, a hard disk (HDD), a removable disk, a CD-ROM, a database, a server, or any other appropriate storage medium.

In an aspect of the present embodiment, the resource unit is an example of “resources of a predetermined unit” and “resources.” The ECCE is an example of a control channel element. The aggregation level is an example of a combination level. The EREG is an example of a resource element group.

### SUPPLEMENT TO EMBODIMENT

Information transmission (notification, reporting) may be performed not only by methods described in an aspect/embodiment of the present specification but also a method other than those described in an aspect/embodiment of the present specification. For example, the information transmission may be performed by physical layer signaling (e.g., DCI (Downlink Control Information), UCI (Uplink Control Information)), upper layer signaling (e.g., RRC signaling, MAC signaling, broadcast information (MIB (Master Information Block), SIB (System Information Block))), other signals, or combinations thereof. Further, an RRC message may be referred to as RRC signaling. Further, an RRC message may be, for example, an RRC connection setup message, an RRC connection reconfiguration message, or the like.

An aspect/embodiment described in the present specification may be applied to a system that uses LTE (Long Term Evolution), LTE-A (LTE-Advanced), SUPER 3G, IMT-Advanced, 4G, 5G, FRA (Future Radio Access), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, UWB (Ultra-WideBand), Bluetooth (registered trademark), other appropriate systems, and/or a next generation system enhanced based thereon.

Determination or judgment may be performed according to a value (0 or 1) represented by a bit, may be performed according to a boolean value (true or false), or may be performed according to comparison of numerical values (e.g., comparison with a predetermined value).

It should be noted that the terms described in the present specification and/or terms necessary for understanding the present specification may be replaced by terms that have the same or similar meaning. For example, a channel and/or a symbol may be a signal. Further, a signal may be a message.

There is a case in which a UE may be referred to as a subscriber station, a mobile unit, subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terms.

An aspect/embodiment described in the present specification may be used independently, may be used in combination, or may be used by switching according to operations. Further, transmission of predetermined information (e.g., transmission of “it is X”) is not limited to explicitly-performed transmission. The transmission of predetermined information may be performed implicitly (e.g., explicit transmission of predetermined information is not performed).

As used herein, the term “determining” may encompasses a wide variety of actions. For example, “determining” may be regarded as calculating, computing, processing, deriving, investigating, looking up (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing, comparing and the like. That is, “determining” may be regarded as a certain type of action related to determining.

As used herein, the phrase “based on” does not mean, unless otherwise noted, “based on only”. In other words, the phrase “base on” means both “based on only” and “based on at least”.

Also, the order of processing steps, sequences or the like of an aspect/embodiment described in the present specification may be changed as long as there is no contradiction. For example, in a method described in the present specification, elements of various steps are presented in an exemplary order. The order is not limited to the presented specific order.

Input/output information, etc., may be stored in a specific place (e.g., memory) or may be stored in a management table. The input/output information, etc., may be overwritten, updated, or added. Output information, etc., may be deleted. Input information, etc., may be transmitted to another apparatus.

Transmission of predetermined information (e.g., transmission of “it is X”) is not limited to explicitly-performed transmission. The transmission of predetermined information may be performed implicitly (e.g., explicit transmission of predetermined information is not performed).

Information, a signal, etc., described in the present specification may be represented by using any one of the various different techniques. For example, data, an instruction, a command, information, a signal, a bit, a symbol, a chip or the like described throughout in the present specification may be represented by voltage, current, electromagnetic waves, magnetic fields or a magnetic particle, optical fields or a photon, or any combination thereof.

The present invention is not limited to the above embodiments and various variations, modifications, alternatives, replacements, etc., may be included in the present invention without departing from the spirit of the invention.

The present application is based on and claims the benefit of priority of Japanese Priority Application No. 2016-003065 filed on Jan. 8, 2016, the entire contents of which are hereby incorporated by reference.

### EXPLANATIONS OF LETTERS OR NUMERALS

UE user equipment
eNB base station
101 signal transmitting unit
102 signal receiving unit
103 decoding unit
201 RF module
202 BB processing module
203 UE control module

1. A user equipment that performs communication with a base station in a radio communication system in which communication is performed through a narrow band, comprising:
a receiving unit that receives a physical downlink control channel from the base station, the physical downlink control channel being arranged in a search space defined by one or more physical downlink control channel candidates which include all or some of a plurality of control channel elements according to a combination level, the plurality of control channel elements being set in a plurality of resources of a predetermined unit in a time direction; and
a decoding unit that decodes a physical downlink control channel arranged in any one of the one or more physical downlink control channel candidates in the search space.

2. The user equipment according to claim 1,
wherein each of the plurality of control channel elements includes a plurality of resource element groups, and
the plurality of resource element groups are distributed in the plurality of resources.

3. The user equipment according to claim 1,
wherein each of the plurality of control channel elements includes a plurality of resource element groups, and
the plurality of resource element groups are arranged in a specific resource in the plurality of resources.

4. A user equipment that performs communication with a base station in a radio communication system in which communication is performed through a narrow band, comprising:
a receiving unit that receives a physical downlink control channel from the base station, the physical downlink control channel being arranged in a search space defined by one or more physical downlink control channel candidates which include all or some of a plurality of resources of a predetermined unit in a time direction according to a combination level; and
a decoding unit that decodes a physical downlink control channel arranged in any one of the one or more physical downlink control channel candidates in the search space.

5. The user equipment according to claim 1,
wherein the narrow band is a frequency band of 180 kHz, and
the resource is a resource that includes one or more subframes and 1 to 12 subcarriers, or one or more slots and 1 to 12 subcarriers.

6. A signal reception method performed by a user equipment that performs communication with a base station in a radio communication system in which communication is performed through a narrow band, the signal reception method comprising:
receiving a physical downlink control channel from the base station, the physical downlink control channel being arranged in a search space defined by one or more physical downlink control channel candidates which include all or some of a plurality of control channel elements according to a combination level, the plurality of control channel elements being set in a plurality of resources of a predetermined unit in a time direction; and
decoding a physical downlink control channel arranged in any one of the one or more physical downlink control channel candidates in the search space.

7. A signal reception method performed by a user equipment that performs communication with a base station in a radio communication system in which communication is performed through a narrow band, the signal reception method comprising:
receiving a physical downlink control channel from the base station, the physical downlink control channel being arranged in a search space defined by one or more physical downlink control channel candidates which include all or some of a plurality of resources of a predetermined unit in a time direction according to a combination level; and
decoding a physical downlink control channel arranged in any one of the one or more physical downlink control channel candidates in the search space.

8. The user equipment according to claim 2,
wherein the narrow band is a frequency band of 180 kHz, and
the resource is a resource that includes one or more subframes and 1 to 12 subcarriers, or one or more slots and 1 to 12 subcarriers.

9. The user equipment according to claim 3,
wherein the narrow band is a frequency band of 180 kHz, and
the resource is a resource that includes one or more subframes and 1 to 12 subcarriers, or one or more slots and 1 to 12 subcarriers.

10. The user equipment according to claim 4,
wherein the narrow band is a frequency band of 180 kHz, and
the resource is a resource that includes one or more subframes and 1 to 12 subcarriers, or one or more slots and 1 to 12 subcarriers.
